(19) United States
(12) Patent Application Publication
(10) Pub. No.: US 2018/0165732 A1
(43) Pub. Date: Jun. 14, 2018

(54) SYSTEM, PLATFORM AND METHOD FOR SHARED ORDER MANAGEMENT

(71) Applicant: SIMPLE ORDER LTD., Tel Aviv (IL)

(72) Inventors: Guy Even EZRA, Herzeliya (IL); Amir ZELIG, Tel Aviv (IL); Arik MEZAN, Tel Aviv (IL); Elliot HOOL, Herzliya (IL)

(21) Appl. No.: 15/892,393

(22) Filed: Feb. 8, 2018

Related U.S. Application Data
(63) Continuation-in-part of application No. 14/322,704, filed on Jul. 2, 2014, now Pat. No. 9,922,355.
(60) Provisional application No. 61/842,400, filed on Jul. 3, 2013.

(51) Int. Cl. G06Q 30/06

(52) U.S. Cl. CPC G06Q 30/0605; G06Q 30/0603

(57) ABSTRACT

There is provided, in accordance with an embodiment of the present invention, a system, platform and method to provide Automatic Inventory, VMI visibility and predictability, and automated Recipe generation and costing in a purchase management system. In one embodiment an automated inventory management system includes a food sales data source associated with a sales processing software; a food waste data source associated with products related to the sales data source; an order management system associated with food merchandise supply processing software; a recipe database including multiple recipes with associated raw material data, designed to extract raw material compositions from items ordered off a food product menu; and an automated inventory system adapted to automatically manage raw material based on sale data and purchase data, and to provide substantially real time inventory data.

### CROSS REFERENCE TO RELATED APPLICATIONS

This application is a Continuation-in-part (CIP) claiming priority from U.S. patent application Ser. No. 14/322,704, filed 2 Jul. 2014, entitled “SYSTEM, PLATFORM AND METHOD FOR SHARED ORDER MANAGEMENT”, which claims priority from U.S. Provisional Patent Application No. 61/842,400, filed 3 Jul. 2013, entitled “A METHOD AND SYSTEM FOR CONNECTING PARTICIPANTS ON THE SUPPLY CHAIN FOR THE PURPOSE OF CREATING COHERENT DATA”, which are incorporated in their entirety herein by reference.

### FIELD OF THE INVENTION

The present invention relates in general to methods and devices useful in supply chain management.

### BACKGROUND OF THE INVENTION

The state of the art today for managing a supply chain generally requires substantial manual configuration. Typically, customers communicate with their established suppliers in a very personal manner. For example, a customer usually calls the regular supplier of a particular commodity or standard set of items and orders a desired quantity of goods. Some customers/retailers send SMS messages, facsimile transmissions or emails with the request. Each new order typically generates three or four different documents: An order, a delivery note, an invoice and a credit note.

Generally, an order may be in the form of a non-editable notification, whether a paper note or a .PDF format file is sent from client to supplier. In some cases a client fills out web-form e.g. to online supplier, OR order is delivered verbally over the phone or sent via SMS.

A paper Delivery/Invoice notice typically arrives together with package either in the post or with the delivery service which is not a postal service. Some delivery services require electronic signature upon delivery. Direct/Online purchases result in immediate non-editable webpage which is confirmation of the sale. An Invoice is usually supplied in the mail together with the mail order (i.e. the purchases item) or with the delivery. With direct deliveries between a supplier and customer (possibly a retailer), the differences between the actual delivery and Delivery Note/Invoice are typically marked in writing over the Delivery Note/Invoice.

The seller (supplier) typically sends a credit note to the buyer (client) in response to returned goods, non-delivered goods, price differences or missing discounts, that were previously invoiced.

The potential for mistakes in the above processes and the subsequent paper trail that follows is great, as the respective documents are usually unorganized and are time and resource consuming to handle. In many cases, in order to better organize the data, these documents are usually inserted manually into the supplier/retailer systems (ERP, accounting systems, or Excel files), where each document is liable to exist in different versions with different data on the retailer and supplier side. Much time and many resources are invested monthly in order to settle such data inconsistencies between retailers and suppliers.

Various enterprise resource planning (ERP) and CRM systems exist to help organize and streamline the process and improve management of the supply chain, but these systems are generally expensive to setup and configure, and are owned and operated by one side of supply chain (either the supplier or the customer).

### SUMMARY OF THE INVENTION

There is provided, in accordance with an embodiment of the present invention, a system, platform and method to provide shared order management and catalog management.

In accordance with some embodiments an order management platform is provided that includes an order server in a communications cloud, coupled to an order database; a shared order platform adapted to facilitate usage by one or more buyers and/or suppliers, wherein the shared order platform includes an open document with order related data layers; and a tokenized link with an address linking to the shared order platform, the tokenized link being adapted to allow entry into the shared order platform via entering a page defined within the tokenized link

In some embodiments the shared order platform includes a trading catalog generated by processing (e.g., aggregation and merging etc.) of multiple shared order platforms by a common buyer and/or supplier.

In some embodiments the tokenized link has a time expiry limitation, for example, allowing entry for n times or for a limited period, to the shared order platform, and includes instructions to execute commands to enable user verification.

In some embodiments the shared order platform may include a multitude of documents related to orders, for example, multiple structured documents may be used that are coded to display multiple versions of the documents, such as to see a history of changes or modifications to respective documents.

In some embodiments the shared order platform includes an inventory tracking module or element shared by an order buyer and an order supplier.

In further embodiments one or more buyers and/or suppliers may be un-registered platform users.

In still further embodiments, the order management system may use data from multiple registered users and/or unregistered users to enable formation of a supply chain network based upon crowd data from users.

In other embodiments the platform executes code to enable generation of a crowd based catalog based on orders processed by the order server.

In accordance with some embodiments, a catalog platform is provided that includes an catalog server in a communications cloud, coupled to an catalog database; a shared catalog platform adapted to facilitate usage by one or more authorized buyers and/or suppliers, wherein the shared catalog platform includes an open catalog document with catalog related data layers; and a tokenized link with an address linking to the shared catalog platform, the tokenized link being adapted to allow entry into the open catalog document via entering a page defined within the tokenized link.

In some embodiments the open catalog document includes a trading catalog generated by aggregation of multiple shared order platforms by a common buyer and/or supplier.

In some embodiments the tokenized link is a unique link to the open catalog document, and includes instructions to execute commands to enable user verification.

In still further embodiments a catalog is generated via processing (e.g., aggregation and merging) of data provided by a crowd of end users.

In accordance with some embodiments, a method for shared order management is provided, which includes generating of an order form, by an order supplier or an order buyer; generating a tokenized link to the order form, the link being coded to allow access to a link holder; and running on an order server one or more files with instructions to execute commands to enable updating of a shared order form, the order form including data layers representing versions of order related documents, for example supply chain documents like invoices, credit/return notes, delivery notes etc.

In some embodiments the versions of orders are from both order suppliers and order buyers.

In some embodiments the method may further include running a program or set of instructions to generate an order catalog based on data input by multiple buyers.

In further embodiments the method may include running a program or set of instructions to generate an order catalog based on data input by multiple suppliers.

In still further embodiments a communication means may be used to communicate between users in a shared order form.

In still further embodiments the shared order form may be used as a communication means between users of the shared order platform.

There is provided, in accordance with an embodiment of the present invention, a system, platform and method to provide Automatic Inventory, Inventory visibility and predictability, Vendor Managed Inventory (VMI) and automated Recipe generation and costing in a purchase management system. In one embodiment an automated inventory management system includes a food sales data source; a food waste data source; an order management system associated with food merchandise supply data source; a recipe database including multiple recipes with associated raw material data, designed to extract raw material compositions from items ordered off a food product menu; and an automated inventory system adapted to automatically manage raw material based on sales data, food waste data, recipe data and/or purchase data, and to provide substantially real time inventory data.

According to some embodiments, the automated inventory management system may perform automated inventory support to food related businesses, for example, restaurants, catering services, food stores, drinks stores, hotels, or other places of entertainment.

According to some embodiments, the automated inventory management system further comprises a sales prediction module.

According to some embodiments, the order management system is adapted to execute code to enable automatic generation of purchase orders based on actual stock quantities.

According to some embodiments, the order management system is adapted to execute code to enable automatic generation of purchase orders based on sales prediction data and data from the automatic inventory management system.

In some embodiments, the order management system is adapted to execute code to enable automatic generation of purchase orders based on PARS values and data from the automatic inventory management system.

In some embodiments, the order management system is adapted to execute code to enable automatic generation of purchase orders based on predicted PARS values and data from the automatic inventory management system.

A method is herein provided for automated inventory management, that in some embodiments includes: supplying sales data to an automated inventory management system; converting sales data to raw materials data; converting waste data to raw material data, supplying purchase order data to an automated inventory management system; and replenishing an automated inventory based on the sales data and the purchase order data.

In further embodiments, the automated inventory management method may include one or more of the following: providing predicted sales data; converting sales data to raw materials data; automatically generating a suggested order; and sending the suggested order to one or more suppliers.

In some embodiments the method of executing automated inventory management includes integrating inventory PAR levels.

In some embodiments the method of executing automated inventory management includes calculating predicted inventory PAR levels.

According to some embodiments, the method further comprises running one or more files with instructions to execute commands to enable automatically converting sales and waste items into raw materials data.

According to some embodiments, the method further comprises generating an alert when inventory levels are at an abnormal level, for example, below a selected level.

According to some embodiments, the method further comprises automatically sending a purchase order to one or more suppliers when inventory levels are at an abnormal level, for example, below a selected level.

According to some embodiments, the method further comprises calculating predicted inventory PAR levels and generating purchase orders based on one or more supplier(s) requests.

According to some embodiments, a method for automated recipe generation is provided, comprising: supplying sales data to an inventory management system; tracking inventory stock usage in the inventory management system; and generating one or more recipes based on the inventory stock usage.

In further embodiments, the automated recipe generation method includes: wherein the recipe generation calculation includes one or more of: deriving a complete recipe from inventory stock usage data; deriving quantities of raw material in a recipe from inventory stock usage data and recipe ingredients; and adding a single new recipe to an existing recipe database, based on inventory stock usage data.

In further embodiments, the automated recipe generation method includes supplying food waste data to an inventory management system.

In further embodiments, the automated recipe generation method includes applying machine learning functionality to enhance recipe accuracy based on inventory stock usage.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of a Supply Chain Management system, according to some embodiments;

FIG. 2 is a schematic system diagram depicting components of a Catalog Management system, according to some embodiments;

FIG. 3 is a flow diagram indicating the process by which shared supply chain management may be implemented, according to some embodiments;

FIG. 4 is a schematic system diagram depicting components of an Automated Inventory Management system, according to some embodiments; and

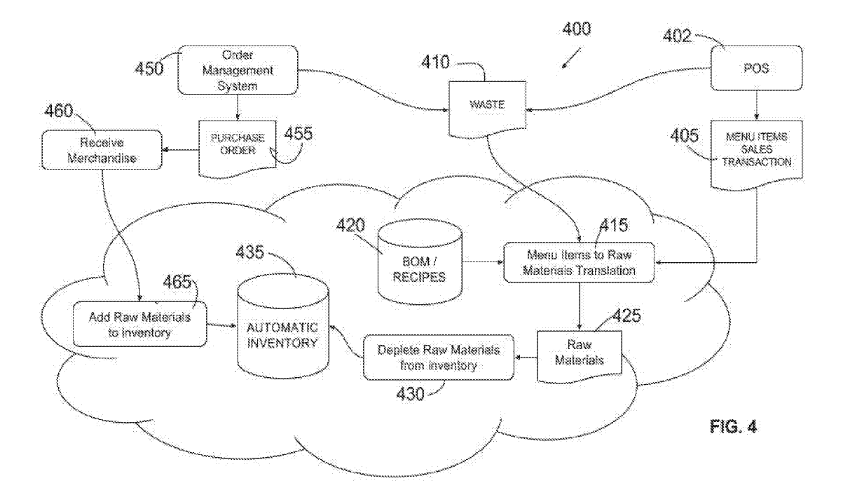

FIG. 5 is a flow diagram indicating the process by which a Vendor-managed inventory (VMI) may be implemented, and for providing alerts for low-stock levels, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

According to some embodiments, retailers and suppliers may communicate about an order using a shared order platform, that includes a shared order document, shared order page or shared order form, which may be accessed through a tokenized page link. For example, such a page link may be communicated using email, SMS, an Application, or other suitable medium. In some embodiments the tokenized page link includes a coded entry to a link, optionally a unique link, that allows authorized users to enter the shared order form and edit and/or view various supply chain elements including views, history, prices, inventory, orders, invoices, catalog items, quantities, etc. Access may be for a limited time, in accordance with selected limited entry rules, opened for one-time usage etc.

According to some embodiments a shared order platform functions as a dynamic, shared, live platform for enabling shared product catalog development, enhancement and management, optionally using interactive links to external data sources, shared documents, catalogs, supply chain players etc. In this way a buyer and/or supplier may generate a dynamic catalog, to be shared by supply chain partners or associates etc., whether or not these partners are registered users or members of the platform.

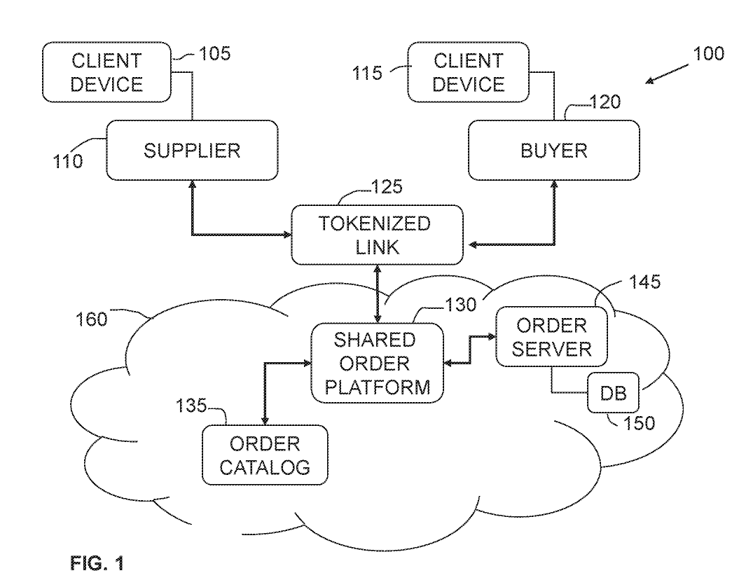

Reference is now made to FIG. 1, which is a schematic system diagram depicting a system 100 for enhancing management of a supply chain and, more particularly, to a system and method for creating a shared order platform 130 that provides a coherent and agreed set of structured data that can be used by one or more suppliers and/or buyers, as well as by other authorized parties. Suppliers 110 and buyers 120, using connected devices 105, 115, connect to a web page or destination, which is typically accessed via a tokenized, unique and/or coded link 125, to which all or authorized users can connect in accordance with optional access rules. The tokenized link 125 links into a shared order destination, document or form, to allow users to connect with one or more customers/suppliers, for substantially real-time customer relationship management (CRM), optionally without requiring both parties to register to the system or download any software. As used herein, the term “tokenized link” may refer to a web page link that may include encoded data, for example including data about the relationship between a single supplier and a single customer together, with a document type and document ID (e.g., including Supplier ID, Customer ID, Order, Order Number etc.), which may be encrypted to enhance its security, make it difficult to hack, and can be used in accordance with pre-configured restrictions (e.g., accessible to specific people or sources, accessible for limited times, etc.).

In some embodiments, shared order platform 130 is situated within a communications cloud 160, which connects platform 130 to an order server 145, which is in turn communicatively coupled to an order database 150. The order server 145 may allow the data processed in platform 130 to generate an order catalog(s) 135 and/or to be in communication with order catalog 140.

In some embodiments, system 100 allows both suppliers and buyers, or other relevant entities, to work on the same coherent agreed set of data, throughout the ordering and delivery process, on the initiation of either party and without requiring both parties to be registered to the system.

In some embodiments, a single registered user, whether the supplier or retailer, may initiate the creation of a whole network of non-registered suppliers and/or buyers (e.g., retailers) that can communicate using shared structured documents or forms, that may integrate documents such as catalogs, orders and invoices/delivery notes, promotions, etc., optionally accessing the structured documents using known communication tools such as email, chats, messaging etc.

Shared order platform 130 may, in some embodiments, include a shared order form or document, typically located on a server or cloud that is accessible to all connected users, and may serve as a ‘neutral ground’ between the buyer and supplier, or other system users, such that all users entering the shared order platform may ‘own’ or jointly own the shared order form or other relevant shared documents, by being able to read and/or write on the form. In some embodiments limited authorization may be given to order platform users, for example, to read only, make comments, make edits, approve orders, change parameters etc. The interactive, modifiable shared order form may generally include the details of the order and possibly a catalog (e.g. belonging to the supplier) or a catalog item/list (e.g., generated by the buyer, possibly through prior interaction, or from an advert or other third-party source or other buyers of the same supplier). In some embodiments the shared order platform integrates two-way communication services that may allow for personal interaction such as an online chat session, an instant messaging service (IM) or the like.

The encrypted “relationship data” in the link-to-order is the communication token. To improve security, it is possible to limit the times a single token can be used. Once expired, the recipient needs to choose a password to continue using the system or wait for the next token to come up with the next order.

In further embodiments, multiple or all orders from the same supplier may be aggregated and modified to create a ‘crowd supplier catalog’. For example, if one buyer orders photocopying paper from a particular supplier and a second buyer orders staples from the same supplier and a third buyer orders pens, then the system identifies that the supplier in question has a catalog of at least paper, staples and pens. In the other direction, if multiple suppliers supply items to a single buyer, the system may combine the orders for the same buyer, and create a “crowd buyer catalog” related to the specific buyer. In still further embodiments multiple orders from multiple suppliers and/or buyers may be aggregated to form crowd catalogs. In some examples such crowd catalogs may be generated for specific or selected areas, segments, industries, locations, etc., or using other relevant criteria for filtering related buyers and/or suppliers.

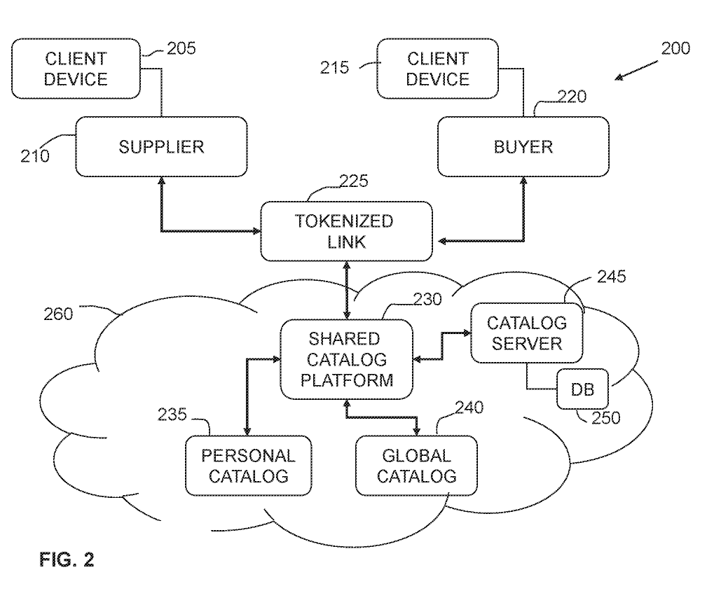

Reference is now made to FIG. 2, which is a schematic system diagram depicting a system 200 and method for creating a shared catalog platform 230 based set of order data between one or more suppliers and/or buyers. Suppliers 210 and buyers 220, using connected devices 205, 215, connect to a tokenized link 225, to which all or authorized users can connect in accordance with access rules. The tokenized link 225 links into a shared dynamic document, hereinafter referred to as a shared catalog platform 230, to allow users to connect with their network of customers/suppliers, for substantially real-time customer relationship management (CRM), optionally without requiring both parties to register to the system or download any software.

In some embodiments, shared catalog platform 230 is situated within a communications cloud 260, which connects platform 230 to a catalog server 245, which is in turn communicatively coupled to a catalog database 150, which will store order related data. The catalog server 245 may allow the data processed in platform 230 to generate personal order catalog(s) 235 (for example, a catalog generated by a seller or buyer), and/or to generate global order catalog(s) 235 (for example, a system based catalog generated by multiple, not necessarily registered sellers and/or buyers). Catalog server may further be in substantially real-time communication with personal order catalog(s) 235 and/or global order catalog(s) 235. In some embodiments generated catalogs may include, for example, customer/seller products and/or services, customized product lists (varieties), pricing levels etc. Even in such cases where crowd data is merged into a single global catalog, each of the crowd data providers (e.g., buyers that created personal catalogs) will be exposed to his/her own personal data and pricing levels etc., thereby enabling users to maintain and manage their parts of their shared catalog platforms.

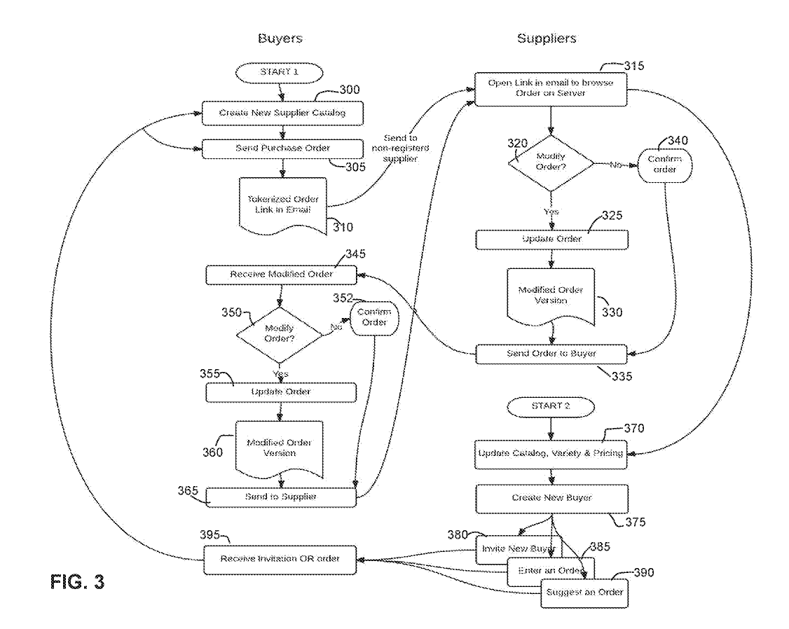

Reference is now made to FIG. 3, which is a flow diagram indicating a process for creating a shared order platform that provides a coherent and agreed set of data between one or more suppliers and/or buyers. As can be seen in the figure, at start scenario 1, at step 300, on the buyers side, an initiating, registered party creates an electronic purchase order, for example on a webpage or alternative document in a shareable communications cloud, data server etc. In some embodiments, at step 305, the initiating buyer may generate a new supplier catalog of wanted order items, whether for one or more, and specific or non-specific suppliers. At step 310 the buyer sends the purchase order and/or the generated catalog to any other party, registered or non-registered, via email/text/messaging etc. as a secured encrypted tokenized webpage link, wherein the secured encrypted link may include, for example, user identification and other vital information for directing the receiving party to a shared platform, destination or form, where the sending and receiving parties may be connected, in relation to the purchase order.

At step 315 the link may be clicked on or otherwise opened, thereby directing the recipient to a shared order platform, that may include an open web form (order form) containing an interactive, modifiable, electronic order and optionally, online two-way communication services between both parties. At step 320 the order (form) may be modified by the supplier, for example, according to their ability to provide the order. At step 325, if the order was modified, it may be updated in the system, or on the form. At step 330 the modified order may be saved as a new version, and optionally the previous versions may also be viewed, similar to a “track changes” type mechanism, where various changes and versions can be viewed for multiple users. At step 335 the modified order is sent to the buyer. At step 340 if the supplier confirms the order “as is”, then the order may be processed, and confirmation may be sent back to the buyer at step 335. In this way, the buying or initiating party is either notified substantially in real time about the receiving party's activities, or is made aware of it on next entering into the form.

At step 345 the buying party can choose to confirm, reject or modify the edited form, and the process may recur until both parties confirm the order. At step 350, the buyer may choose to modify the edited form, which will update the order at step 355. The updated order will be saved as a modified version of the order at step 360, which will be sent back to the supplier at step 365. In the case where the buyer chooses to confirm the updated order, the order is confirmed at step 352, and optionally returned to the supplier to carry out the order. The communication loop between the buyer and supplier may continue until one of the sides confirms the order for execution, or cancels the order etc.

In another embodiment, the process may begin from the supplier side, at start 2 or be a follow-on process from an order received by the supplier in step 315, optionally without registering to the system. At step 370 a supplier may enter or upload on the system a product or item offering, or catalog of offerings. This offering may generally include item details, varieties, prices, numbers, specifications etc. At step 375 the supplier may enter or create one or more new buyers, which may be for example, existing, potential, registered or non-registered buyers, for which the supplier has a connection. For example, at step 380 an invitation for a new buyer may be prepared, for example, which invites the potential buyer to see the offering, optionally via a link sent to the buyer's email, mobile number, or other linkage medium. At step 385 the supplier may enter an order to modify, polish or confirm the order etc. At step 390 the supplier may suggest an order, for example, by customizing the order, making suggestions, referring to a catalog etc. At step 395 the invitation or order may be received by the potential buyer, who may then, at step 300 use the order to create a catalog, and/or at 350, the buyer may choose to confirm or modify the order.

According to some embodiments, the system may process delivery notes, invoices, credit/return notes etc. issued by the parties with respect to the same order, in the shared order form. In this way the shared order form may also function as a platform for delivery note management, order invoice management, inventory tracking management etc.

According to some embodiments, registered and/or non-registered parties can use the shared order form as a communication mean, and as a means to share order data, such as order history, past orders placed between the parties, catalogs and pricing, view reports of the relationships, post promotions and special offers, chat, etc.

In some embodiments, a registered and/or non-registered party can use the order link to present all the orders received by a supplier from different customers and/or all orders supplied to a buyer from different suppliers.

In further embodiments the system may enable generation of global database based on different orders from a supplier (“crowd catalog”, discussed above). In one embodiment a suppliers catalog may be generated only if authorized by a supplier. In one such example a supplier may take ownership of all orders from them by various buyers, optionally based on all orders from the suppliers' email address or messaging address, and release a derived suppliers catalog if and when they desire. In other embodiments, each retailer may own its own personal supplier catalog. In an example of a case where the supplier does not permit using of related order data to form a global catalog, the system may use the order data to create a shared catalog template that may be used as a template for creating additional personal catalogs, but with no reference to the supplier (i.e., owner of the email address). In such a case, buyers wanting to create a supplier catalog may be required to assign a real contact to the supplier entity that was created from the aggregated template.

In one example a global catalog for a supplier may be generated based on crowd sourcing, without any contribution from the supplier. Such a catalog may be made available to new users or specified group of users. In some embodiments the system allows for flexible catalog generation based on matches between personal catalogs and the global catalog.

In still further embodiments, as can be seen on FIG. 3, a supplier can work with multiple buyers, and a buyer can work with multiple suppliers. In this way the order management system can use crowd data to connect a registered user to new buyers and/or suppliers, and thereby enhance or expand their supply chain network, based on a global supply chain network generated by the system.

In further embodiments the crowd generated catalogs may be used to generate recommended prices, deals, problems, new suppliers or buyers etc.

In further embodiments the system can provide aggregated reports to suppliers and/or buyers.

In further embodiments shared order form contains a two-way communication capability (e.g. chat, email, IM, Skype™, Whatsapp™ etc.), as well as the other capabilities described above.

According to some embodiments, “tokenized” or non-tokenized web page links may be used to include required purchase order encoded data.

In accordance with some embodiments of the present invention, a method for automatic inventory management is provided, for example, for managing a food inventory system. As can be seen, the automatic inventory management system 400 get sales data from various sources (POS, online ordering system, Excel/csv files, manually upload, etc.), at step 402. Automatic inventory management system 400 can optionally get waste data at step 410, from various sources (POS, Excel/csv files, manually uploaded, and from other digital sources),In some examples, waste data may include records of any raw materials not used in food preparation, preparation or prepared dishes or products which are damaged, spoiled, left-over at end of day, returns of merchandise that cannot be re-used, expired merchandise, etc. At step 405, order items, for example menu items from a restaurant, are detailed as part of a sales transaction. At step 415, waste related data and/or the sale related menu items data may be processed as part of the automatic inventory management process, by breaking down each sale or menu item into raw materials optionally based on inserted or automatically generated recipes, optionally in real-time, and optionally using a BOM or recipes database, at step 420. At step 425, as a result of step 415, a list of consumed raw materials is extracted. At step 430 the current inventory levels for raw materials may be reduced based on actual raw material consumed, as extracted from the sales and/or waste data, optionally in real-time. The updated inventory status is updated to the automatic inventory, at step 435.

At step 450 the order management or purchasing system receives an order, for example, from the restaurant, to purchase more raw materials or merchandise from suppliers (further, purchase orders may be generated as described above). At step 455, the purchase order is generated and sent to a supplier. At step 460 the order or merchandise is received. At step 465, the processed purchased order data, including raw materials received from suppliers, may be updated to the automated inventory.

According to some embodiments, a vendor managed inventory (VMI) in conjunction with an automated inventory may enable a vendor to manage client's inventory based on actual usage of raw materials, optionally in real time.

According to some embodiments, a recipe building module may enable processing of sales data and waste data in the automated inventory.

According to some embodiments, the automatic inventory may enable a purchase order to be sent automatically to a supplier, or optionally to be sent after receiving retailer approval.

According to some embodiments, the automatic inventory may enable a purchase order to be automatically generated based on supplier's request.

According to some embodiments, the automatic inventory may enable insertion of true-up count data, to generate inventory “leakage” reports.

In still further embodiments of the present invention, the automatic inventory may enable enhanced Vendor-managed inventory (VMI) management, to deliver, for example, real time visibility into inventory levels and predictions to suppliers (e.g., wholesaler, vendor, manufacturer, central kitchen; automatically replenished client inventories based on needs and supplier's distribution plans etc.). Further, the automatic inventory may enable enhanced Vendor-managed inventory (VMI) management, to provide retailers expected replenishment requirements data to suppliers, for planning purposes and efficient management of their sales force.

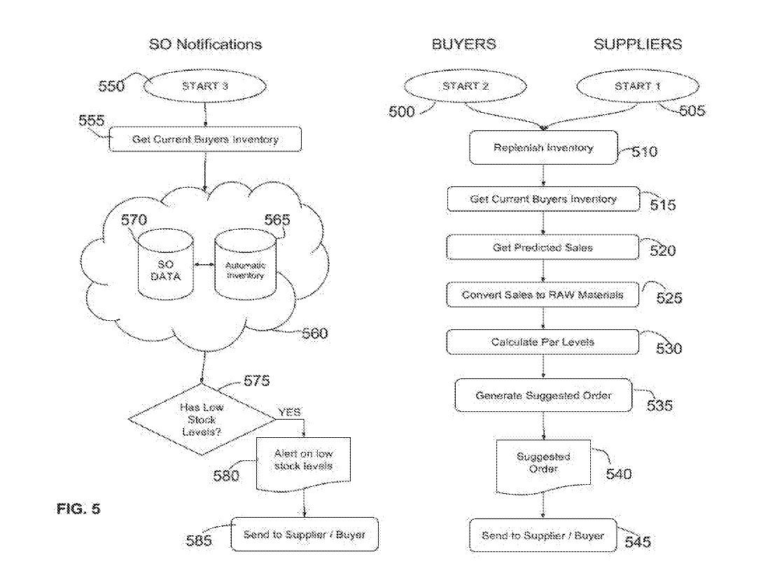

In accordance with some embodiments of the present invention, a method for providing Automatic Inventory Management is provided, for example, for managing a food inventory system. As can be seen with reference to FIG. 5, at step 500, buyers of merchandise, for example restaurants requiring raw material or ingredients, can automatically generate supply requests, the deliveries of which are used to replenish the buyer's inventory. Further, and optionally in parallel, at step 505, suppliers can initiate the replenishment of the customer's inventory. At step 515, the current buyers' inventory status is generated in the Automatic Inventory Management system. At step 520 predicted sales data may be added to the Automatic Inventory Management system, to help the automated inventory better suggest purchase and supplies pathways to keep the inventory optimally replenished. At step 525 the predicted sales data may be converted to Raw materials data. Predictions may become more and more accurate as larger samples of data are mined. At step 530 “optimal” suggested of Par levels may be calculated based on steps 515 and 525 or manually provided, and at step 535, suggested order data may be generated. At step 540 the suggested purchase order may be prepared, and forwarded to suppliers and/or buyers, at step 545.

In accordance with some embodiments of the present invention, a method for providing Automatic Inventory Management alerts is provided, for example, for managing a food inventory system. At step 555 current buyers inventory data may be received or calculated by the Automatic Inventory Management System, and transferred to a communications cloud, at step 560. At step 565 the inventory data may be processed in the automatic inventory database, optionally using predicted sales data from the database at step 570. Following processing, the system is challenged at step 575 to determine if there are low stock or inventory levels, based on actual merchandise, predicted sales and outstanding purchase order data etc. If there is a low stock level, at step 580 a stock level alert is generated, and at step 585, such an alert may be sent to either supplier(s) and/or buyer(s).

According to some embodiments, the automatic inventory may enable alerts to be generated once the inventory dips below a selected pre-fixed level (for a retailer and/or a supplier), or based on a Predicted Sales module, and/or at as pre-configured warning level or threshold.

According to some embodiments, the automatic inventory may enable orders to be generated based on pre-set or calculated par level.

According to some embodiments, the automatic inventory may enable anticipated quantities and current inventory levels to generate a purchase order.

In some embodiments, a projected sales module may be integrated, to help predict orders and thereby enhance the data in the automated inventory, which may further enable the order management systems to predict requirements based on anticipated sales.

According to some embodiments, an optimal level of inventory (e.g. PAR) may be maintained in the automated inventory, and may be enhanced over time as more data is available in the system.

According to some embodiments, single or multiple recipe building can be provided using a food inventory system, as described herein.

In some embodiments, the food inventory system, optionally, the food automated inventory system, may enable automatic multiple recipe building and costing, by enabling a customer to insert a list of menu items/preparations, or use an imported list from a POS etc. Further, based on actual sales, waste, actual inventory counts and actual deliveries, the system may assign ingredients to menu items, and calculate and assign quantities to each ingredient. In addition, the system may derive costs for the provided recipes, and may further calculate margins, for example, based on costs of supplies, sale prices from the POS, and real-time inventory level tracking. Moreover, the system may further refine the results as more information is generated. In some embodiments machine learning functionality may be integrated to facilitate data processing, such that as more inventory counts, the accuracy of the recipes will be increased.

According to some embodiments, a recipe generating algorithm may be executed to automatically generate recipes based on product orders. For example, the automatic inventory system can record sales order, record inventory raw material changes, and calculate assumed recipes used to produce the orders, based on the inventory changes. Of course, the more instances that are tracked, the more accurate the recipe generation may be. In further embodiments, machine learning functionality may be integrated to generate more accurate recipes based on inventory stock usage.

In one example, if we assume a restaurant sells two types of burgers—regular and big. Each has a bun, meat patty and special sauce. Assuming the opening Inventory count: =50 Buns, 5 Kg meat and 1 Lrof sauce. During day 1—the sales data is 10 regular and 5 big burgers, end of day count: Buns=33, meat=3.25 Kg, sauce=0.6 L. Waste for the day—2 buns. On day Day 2: sales included 8 regular and 8 big. End of day count was: 17 buns, 1.25 kg meat, and 1.12 L of sauce; and 0 waste. Further, 1 L of sauce was ordered by the restaurant and delivered. Based on the above, the system may calculate that the buns quantity of the total order is 10x+5x+2=17 x=1, meat quantity is 10x+5y=1.75 kg and 8x+8y=2 Kg=>x=0.1 Kg, and y=0.15 Kg.; Sauce quantity=10x+5y=0.4 L.; and 8x+8y=(0.6 L+1 L-1.12 L)=0.48 L=>x=0.02 L y=0.04 L. The above example enables building of a predicted recipe for a Regular Burger: 1 bun, 100 g. meat and 20 ml. sauce; and for a Big Burger: 1 bun, 150 g. meat and 40 ml. sauce. Further, the above automatically generated recipes may be automatically priced, and the margin may be calculated. The above calculations may be further modified based on future counts. In general, to find the quantity of ingredients that appear in n recipes, the system may require at least n inventory counts.

In some embodiments, a food inventory system powered by the food automated inventory system may enable business owners or workers to insert lists of ingredients to the menus and/or preparation lists. Further, based on actual sales, waste, actual inventory counts and/or actual deliveries, the system may calculate and assign quantities to each ingredient. In addition, the system may process the data received to generate costs for the recipes being handled, and calculates margins. Moreover, results may be refined by the system, as more information is generated. In some embodiments machine learning functionality may be integrated to facilitate data processing.

In some embodiments, the food automated inventory system may enable single recipe building, by enabling a customer to insert a single menu items/preparations/names. Further, based on actual sales data, waste data, opening and closing inventory counts, and actual deliveries, the system may assign ingredients to such menu item, calculate and assign quantities to each ingredient. In addition, the system may derive costs for the provided recipe, and may further calculates margin. Moreover, the system may further refine the results as more information is generated. In some embodiments machine learning functionality may be integrated to facilitate data processing.

In some embodiments, the food automated inventory system may enable customers to choose a recipe and add ingredients. Further, for each ingredient the customer may add a “beginning of period” dedicated quantity. The system may get the sales of the specific recipe from the POS or other source during a specified period. Subsequently, at the end of the specified period, the customer may insert an “end of period” remaining quantity for each ingredient, as well as waste related data. Furthermore, the system may calculate and assign quantities to each ingredient. In addition, the system may process the data received to generate costs for the recipe being handled, and calculates margin. Moreover, results may be refined by the system, as more information is generated. In some embodiments machine learning functionality may be integrated to facilitate data processing.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An automated inventory management system, comprising:
a food sales data source;
a food waste data source;
an order management system;
a recipe database including multiple recipes with associated raw material data, designed to extract raw material compositions from items ordered off a food product menu; wherein the automated inventory system is adapted to automatically manage raw material based on food sales data, food waste data, recipe data, and purchase data, and to provide substantially real time inventory data.

2. The automated inventory management system of claim 1, wherein the inventory management system is adapted to support one or more food related businesses selected from the group consisting of restaurants, catering services, food stores, drinks stores, hotels, or other places of entertainment.

3. The automated inventory management system of claim 1, further comprising a sales prediction module.

4. The automated inventory management system of claim 1, wherein the order management system is adapted to execute code to enable automatic generation of purchase orders based on actual stock quantities.

5. The automated inventory management system of claim 1, wherein the purchase orders are generated based on PARS values.

6. The automated inventory management system of claim 3, wherein the order management system is adapted to execute code to enable automatic generation of purchase orders based on sales prediction data.

7. The automated inventory management system of claim 1, wherein the purchase orders are generated based on predicted PARS values.

8. A method for automated inventory management, comprising:
supplying sales data to an automated inventory management system;
converting sales data to raw materials data;
supplying purchase order data to an automated inventory management system; and
replenishing an automated inventory based on the sales data and the purchase order data.

9. The method of claim 8, further comprising a sales prediction module.

10. The method of claim 9, further comprising providing inventory PAR levels based on current levels of inventory stock and predicted sales.

11. The method of claim 8, further comprising running one or more files with instructions to execute commands to enable automatically converting sales and waste items into raw materials data.

12. The method of claim 8, further comprising generating an alert when inventory levels are at an abnormal level.

13. The method of claim 9, further comprising generating a suggested order based on a current level of inventory stock and predicted sales.

14. The method of claim 8, further comprising automatically sending a purchase order to one or more suppliers when inventory levels are at an abnormal level.

15. The method of claim 8, further comprising calculating predicted inventory PAR levels based on one or more supplier(s)requests.

16. A method for automated recipe generation, comprising:
supplying sales data to an inventory management system;
tracking inventory stock usage in the inventory management system; and
generating one or more recipes based on the inventory stock usage.

17. The method of claim 16, further comprising supplying food waste data to an automated inventory management system.

18. The method of claim 16, further comprising applying machine learning functionality to enhance recipe accuracy based on menu and/or product orders.

19. The method of claim 16, wherein the recipe generation calculation includes one or more of: deriving a recipe from inventory stock usage data; deriving quantities of raw material in a recipe from inventory stock usage data and recipe ingredients; and adding a single new recipe to an existing recipe database, based on inventory stock usage data.
